(19) United States
(12) Patent Application Publication
(10) Pub. No.: US 2009/0120233 A1
(43) Pub. Date: May 14, 2009

(54) Control for a vehicle

(75) Inventor: Markus Hornung, Steinenbronn (DE)

Correspondence Address: CROWELL & MORING LLP;INTELLECTUAL PROPERTY GROUP, P.O. BOX 14300, WASHINGTON, DC, 20044-4300, US

(73) Assignee: Daimler AG, Stuttgart (DE)

(21) Appl. No.: 11/912,070

(22) PCT Filed: Apr. 11, 2006
(86) PCT No.: PCT/EP06/03308

§ 371 Date: Apr. 17, 2008

(30) Foreign Application Priority Data
Apr. 20, 2005 (DE) 10 2005 018 220.8

(51) Int. Cl. B60K 37/06

(52) U.S. Cl. 74/523

(57) ABSTRACT

A control for a vehicle, has at least one activatable momentary contact, controlling and/or switching element for actuating motor-vehicle-internal functions. The control is arranged on the handbrake lever of a manually activated handbrake of the vehicle.

This application is a national stage of PCT International Application No. PCT/EP2006/003308, filed Apr. 11, 2006, which claims priority under 35 U.S.C. § 119 to German Patent Application No. 10 2005 018 220.8, filed Apr. 20, 2005, the disclosure of which is expressly incorporated by reference herein.

### BACKGROUND AND SUMMARY OF THE INVENTION

The invention relates to a control for a vehicle, having at least one activatable momentary contact, controlling and/or switching element for actuating motor-vehicle-internal functions.

A wide variety of such controls are known and they are generally located on steering column switches, dashboards and/or center consoles of vehicles. Vehicle-internal functions such as, for example, lighting, air conditioning, seat comfort and the like can be actuated by means of the momentary contact, controlling and/or switching elements of the control. In addition to the pure momentary contact, controlling and/or switching elements, displays which provide visual assistance are generally provided in this context.

Controls basically require installation space. Particularly in modern, relatively small motor vehicles, comparatively little installation space is available. German patent document DE 196 47 460 A1 discloses a control in the region of a switching lever for a transmission of a motor vehicle. Due to the movement of the switching lever when a gear speed change occurs, such an arrangement is comparatively costly and disruptive.

One object of the present invention is to provide a control which takes up as little installation space as possible, or advantageously takes up no installation space, and is nevertheless satisfactorily accessible to a person steering the vehicle.

This and other objects and advantages are achieved by the control apparatus according to the invention, in which the control is arranged on the handbrake lever of a manually activatable handbrake of the vehicle. Corresponding installation space is to be made available for a handbrake lever. Because the control is arranged on the handbrake lever, it requires no additional installation space. Furthermore, an ergonomically favorable position is obtained since the handbrake lever is generally arranged in the driver's compartment in an ergonomically favorable fashion. Furthermore, the interior design is not adversely affected since the control can be integrated into the design of the interior or of the handbrake lever.

In this context it is advantageously possible for the control to be integrated at least partially into the handbrake lever. As a result a very compact embodiment of the control can be implemented, which embodiment is small in size and not visually obtrusive.

In one advantageous embodiment of the invention, a hand rest section with a contact sensor system is provided, and the momentary contact, controlling and/or switching element is actuated for the purpose of activation only if the operator's hand is in contact with the hand rest section. This feature ensures that the motor-vehicle-internal functions can actually be actuated only if the hand touches the hand rest section. Undesired actuation of vehicle-internal functions when the momentary contact controlling and/or switching elements are touched randomly or undesirably is prevented. Actuation of the vehicle-internal functions is possible only if the hand of the operating person intentionally touches the hand rest section. This increases the operational reliability of the control.

The hand rest section (for the ball of the hand to rest on) can also be arranged on the rear upper side of the control facing away from the direction of travel. Advantageously, the hand rest section is arranged so that, when the handbrake is activated, it is not touched by the hand of the operating person, which ensures that one of the pushbutton momentary contact switches is not undesirably operated when the handbrake is activated.

According to a further advantageous embodiment of the invention, momentary contact, controlling and/or switching elements in the form of a touchpad, activation wheel, pushbutton momentary contact switch, sliding momentary contact switch and/or joystick, are provided on the upper side of the control lying at the front in the direction of travel. Favorable actuation of motor-vehicle-internal functions can therefore be carried out on the upper side, which also lies in the field of vision of the person operating the vehicle.

According to a further embodiment of the invention a pushbutton release switch is provided at the free end of the handbrake lever pointing in the direction of travel, for releasing a latched position of the handbrake, and the momentary contact, controlling and/or switching element which lies at the top and in the front in the direction of travel, is arranged in a depression or trough in such a way that it is not activated when the pushbutton release switch is activated. This arrangement increases the functional reliability of the control to the extent that when the handbrake is activated, undesired activation of the control cannot occur or can only occur with difficulty.

According to a further embodiment of the invention, the power supply and data communication of the control are provided by means of lines which are routed on or in the handbrake lever.

Other objects, advantages and novel features of the present invention will become apparent from the following detailed description of the invention when considered in conjunction with the accompanying drawings.

### BRIEF DESCRIPTION OF THE DRAWINGS

FIG. 1 shows a control according to the invention, which is arranged on a handbrake lever; and

FIG. 2 shows individual parts of the control according to FIG. 1.

### DETAILED DESCRIPTION OF THE DRAWINGS

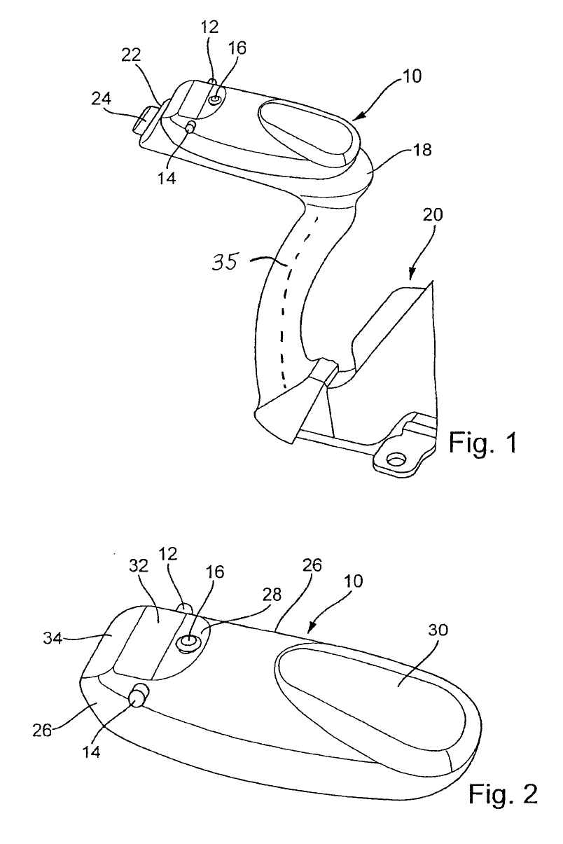

FIG. 1 illustrates a control 10 for a vehicle, which comprises two momentary contact elements 12, 14 and a control 16. The control is arranged here on a handbrake lever 18 of a manually activatable handbrake 20 of the vehicle (not shown). At its free end 22 which points in the direction of travel, the handbrake lever 18 provides a pushbutton release switch 24 with which the handbrake lever can be released from a latched position.

As is apparent from the enlargement in FIG. 2, the two momentary contact elements 12, 14 are arranged as sections of the two longitudinal sides 26 of the control which are located at the front in the direction of travel as a pushbutton momentary contact switch. When a hand is placed on the controls 10, the two momentary contact elements 12 and 14 can each be activated with the thumb or index finger/middle finger of the operating person.

The control 16, which is embodied as a joystick element, is arranged on the upper side 28, at the front in the direction of travel. It can advantageously be operated with the index finger, in which case one of the two momentary contact elements 12 can then advantageously be operated with the middle finger.

The control has, on its upper side facing away from the direction of travel, a hand rest section 30 for the ball of a hand of the operating person to rest on. The hand rest section 30 comprises here a contact sensor system (not illustrated) with which it is possible to determine whether the hand of the operating person touches the hand rest section. Moreover, the control is configured so that the momentary contact elements 12 and 14 and the control 16 are activated for the purpose of activation only if the hand of the operating person rests on the hand rest section 30. This prevents undesired activation of the momentary contact elements 12, 14 and of the control 16.

As shown in FIG. 2, the control 16 lies in a depression 32, which prevents undesired activation of it when the pushbutton release switch 24 is activated. Nevertheless, to be able to activate the pushbutton release switch 24, a flattened portion 34 is provided on the control 10 on the front side facing in the direction of travel.

Instead of pushbutton momentary contact switches 12, 14 and the joystick 16, it is also possible to provide other momentary contact, controlling and/or switching elements such as, for example, switching wheels, switching balls or touchpads.

As becomes clear from FIGS. 1 and 2, the control 10 extends in the longitudinal direction over the entire length of the handbrake lever 18 to be grasped. The control 10 can be arranged on the upper side of the handbrake lever, or else at least be integrated partially into it. Moreover, according to a feature of the invention, a power supply and data communication of the control are provided via lines 35 that are routed on or in the handbrake lever.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1.-9. (canceled)

10. Control apparatus for a vehicle, comprising:
at least one activatable momentary contact, controlling or switching element for actuating motor-vehicle-internal functions;
wherein the control is arranged on the handbrake lever of a manually activatable handbrake of the vehicle.

11. The control apparatus as claimed in claim 10, wherein the control is at least partially integrated into the handbrake lever.

12. The control apparatus as claimed in claim 10, wherein:
the handbrake lever includes a hand rest section with a contact sensor system; and
the momentary contact, controlling and/or switching element is actuatable only if the operator's hand is in contact with the hand rest section.

13. The control apparatus as claimed in claim 12, wherein the hand rest section is arranged on a rear upper side of the control, facing away from the direction of travel.

14. The control apparatus as claimed in claim 12, wherein the hand rest section is arranged so that when the handbrake is activated it is not touched by the hand of the operating person.

15. The control apparatus as claimed in claim 10, wherein a pushbutton momentary contact switch is provided on sections of opposing longitudinal sides of the control which lie at the front in the direction of travel.

16. The control apparatus as claimed in claim 10, wherein:
momentary contact, controlling and/or switching elements are provided on the upper side of the control lying at the front in the direction of travel; and
said elements comprise at least one of a touchpad, activation wheel, pushbutton momentary contact switch, sliding momentary contact switch and joystick.

17. The control apparatus for a vehicle, wherein:
a pushbutton release switch for releasing a latched position of the handbrake is provided at a free end of a vehicle handbrake lever pointing in a direction of travel of the vehicle; and
a momentary contact, controlling and/or switching element is disposed at the top and in the front relative to a direction of travel of the vehicle; and
said element is arranged in a depression such that it is not activated when the pushbutton release switch is activated.

18. A control apparatus wherein the power supply and data communication of the control are provided via lines which are routed on or in the handbrake lever.

19. Control apparatus for a vehicle, comprising:
a handbrake lever for controlling braking of the vehicle;
at least one digitally actuable element for controlling motor vehicle functions other than braking of the vehicle;
wherein said at least one digitally actuable element is mounted on said handbrake lever.

20. The control apparatus according to claim 19, wherein:
said handbrake lever has a hand rest section in the form of a contact sensor which detects the presence of an operator's hand resting thereon;
said digitally actuable element is operative to control said motor vehicle functions only if presence of a hand is detected on said hand rest section; and
said hand rest section is situated at a location on said handbrake lever, such that, when the hand brake lever is actuated to control braking, it is not touched by the operator's hand.

21. The control apparatus as claimed in claim 20, wherein a pushbutton momentary contact switch is provided on sections of opposing longitudinal sides of the control which lie at the front in the direction of travel.
